(19) United States
(12) Patent Application Publication
(10) Pub. No.: US 2019/0386968 A1
(43) Pub. Date: Dec. 19, 2019

(54) METHOD TO SECURELY BROKER TRUSTED DISTRIBUTED TASK CONTRACTS

(71) Applicant: General Electric Company, Schenectady, NY (US)

(72) Inventors: Brandon Stephen GOOD, Niskayuna, NY (US); Willard Monten WISEMAN, Amsterdam, NY (US); Benjamin Edward BECKMANN, Niskayuna, NY (US); Li ZHANG, Niskayuna, NY (US)

(21) Appl. No.: 16/010,911

(22) Filed: Jun. 18, 2018

(51) Int. Cl. H04L 29/06; H04L 9/30; G06Q 20/14

(52) U.S. Cl. CPC H04L 63/0442; H04L 9/30; G06Q 2220/00; G06Q 20/14; H04L 2209/38; H04L 63/0421

(57) ABSTRACT

According to some embodiments, an edge device may receive, via a secure, distributed transaction ledger (e.g., associated with blockchain technology), information about a task contract published by a publisher device including an indication of a benefit and encryption information. The task contract might be associated with, for example, a compute transaction task and/or a physical task. The edge device may evaluate the received information in accordance with resources locally available at the edge device, and, responsive to said evaluation, transmit to the secure, distributed transaction ledger an indication of acceptance of the published task contract. According to some embodiments, the edge device may execute the published task contract, and, upon completion, arrange to receive the benefit associated with the published task contract.

### BACKGROUND

Some embodiments disclosed herein relate to compute transactions and, more particularly, to blockchain enabled securely brokered trusted distributed compute transactions.

A device or application may want to perform a task that involves a set of compute transactions. For example, an image sensor might want to analyze a stream of images in connection with an image recognition algorithm. The device or application, however, might not have the compute resources (Central Processing Unit (“CPU”) speed, bandwidth, memory, bandwidth, etc.) locally available to perform that particular set of compute transactions. Note that there may be a substantial number compute cycles available on edge devices (Personal Computers (“PCs”), smartphones, robots, autonomous vehicles, etc.). With sufficiently high bandwidth connectivity and resource availability, the set of compute tasks might be shared between edge devices when an original requesting device is not able to handle the work. Note that the edge devices might be either physically located at the same facility (e.g., a local network) or separated around the globe. Note that various scenarios may be associated with unique problems about how to manage resource visibility, privacy (e.g., an edge device might not want to identify itself to a central authority that manages the distribution of tasks), latency, trust, etc.

It would therefore be desirable to provide systems and methods to efficiently and securely broker trusted distributed compute transactions.

### SUMMARY

According to some embodiments, an edge device may receive, via a secure, distributed transaction ledger (e.g., associated with blockchain technology), information about a task contract published by a publisher device including an indication of a benefit and encryption information. The edge device may evaluate the received information in accordance with resources locally available at the edge device, and, responsive to said evaluation, transmit to the secure, distributed transaction ledger an indication of acceptance of the published task contract. According to some embodiments, the edge device may execute the published task contract, and, upon completion, arrange to receive the benefit associated with the published task contract.

Some embodiments comprise: means for receiving, at an edge device computer processor from a secure, distributed transaction ledger, information about a task contract published by a publisher device including an indication of a benefit and encryption information; means for evaluating the received information in accordance with resources locally available at the edge device; and, responsive to said evaluation, means for transmitting to the secure, distributed transaction ledger an indication of acceptance of the published task contract.

Some embodiments comprise: means for transmitting, via a secure, distributed transaction ledger, information about a task contract published by a publisher device including an indication of a benefit and encryption information; means for receiving from an edge device via the secure, distributed transaction ledger an indication of acceptance of the published task contract; and, upon completion of the published task contract, means for arranging to provide the benefit to the edge device.

Technical effects of some embodiments of the invention are improved ways to efficiently and securely broker trusted distributed compute transactions. With these and other advantages and features that will become hereinafter apparent, a more complete understanding of the nature of the invention can be obtained by referring to the following detailed description and to the drawings appended hereto.

### BRIEF DESCRIPTION OF THE DRAWINGS

FIG. 1 is a high-level block diagram of a system according to some embodiments.

FIG. 2 is an edge device method in accordance with some embodiments.

FIG. 3 is a publisher device method in accordance with some embodiments.

FIG. 4 is a system implementing blockchain enabled compute transaction distribution with validation according to some embodiments.

FIG. 5 is a system implementing blockchain enabled compute transaction distribution with multiple devices in accordance with some embodiments.

FIG. 6 is an information flow diagram according to some embodiments.

FIG. 7 is a more detailed edge device method in accordance with some embodiments.

FIG. 8 is a more detailed publisher device method in accordance with some embodiments.

FIG. 9 illustrates a platform according to some embodiments.

FIG. 10 is a portion of a task contracts database in accordance with some embodiments.

FIG. 11 illustrates an encryption technique according to some embodiments.

FIG. 12 is a distributed transaction ledger reference architecture according to some embodiments.

FIG. 13 is a blockchain enabled brokered distributed compute transaction display in accordance with some embodiments.

### DETAILED DESCRIPTION

In the following detailed description, numerous specific details are set forth in order to provide a thorough understanding of embodiments. However, it will be understood by those of ordinary skill in the art that the embodiments may be practiced without these specific details. In other instances, well-known methods, procedures, components and circuits have not been described in detail so as not to obscure the embodiments.

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

A device might want to have compute transactions executed (e.g., associated with an Artificial Intelligence (“AI”) algorithm) but not have the compute resources available to perform the task. To solve such a problem, a system 100 includes a number of edge devices 110 each having a communication port to exchange information via a network 102 (e.g., the Internet). Similarly, a publisher device 120 may have a communication port to exchange information with the edge devices 110.

According to some embodiments, the edge device 110 and/or publisher device 120 record data in a secure, distributed transaction ledger 190. For example, the publisher device 120 might publish or post information about a compute task that it like to have performed via the secure, distributed transaction ledger 190 in accordance with any of the embodiments described herein. The transaction ledger 190 might be associated with, for example, blockchain technology that can be verified via a remote operator or administrator device. According to some embodiments, the distributed transaction ledger might be associated with the HYPERLEDGER® blockchain verification system. Note that the devices 110, 120 could be completely de-centralized and/or might be associated with a third party, such as a vendor that performs a service for an enterprise.

The edge device 110 and/or publisher device 120 might be, for example, associated with a PC, laptop computer, a tablet computer, a smartphone, an enterprise server, a server farm, and/or a database or other storage devices. According to some embodiments, an “automated” edge device 110 may automatically read and/or record information in the transaction ledger 190 via a blockchain verification process. As used herein, the term “automated” may refer to, for example, actions that can be performed with little (or no) intervention by a human.

As used herein, devices, including those associated with the edge device 110 and any other device described herein, may exchange information via any communication network 102 which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

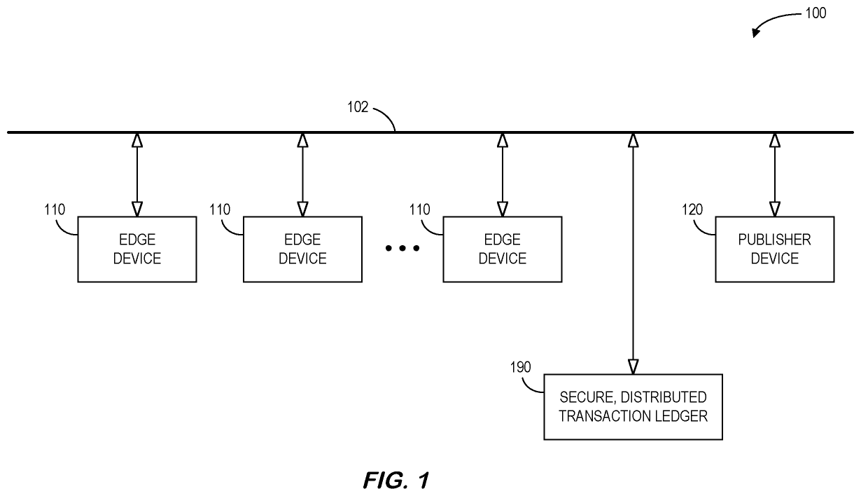

The devices 110, 120 may store information into and/or retrieve information from data stores. The data stores might, for example, store electronic records representing compute tasks and contracts, compute resource requirements, payment details, etc. The data stores may be locally stored or reside remote from the devices 110, 120. Although a single publisher device 120 is shown in FIG. 1, any number of such devices may be included. Moreover, various devices described herein might be combined according to embodiments of the present invention. For example, in some embodiments, the edge device 110 and task contracts database and/or other devices might be co-located and/or may comprise a single apparatus.

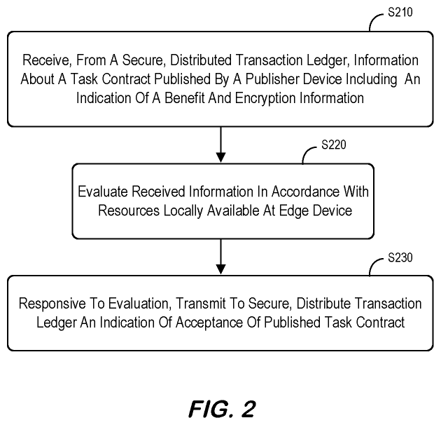

Note that the system 100 of FIG. 1 is provided only as an example, and embodiments may be associated with additional elements or components. According to some embodiments, the elements of the system 100 broker blockchain enabled distributed compute transactions. For example, FIG. 2 illustrates an edge device method that might be performed by the system 100 described with respect to FIG. 1, or any other system, according to some embodiments of the present invention. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

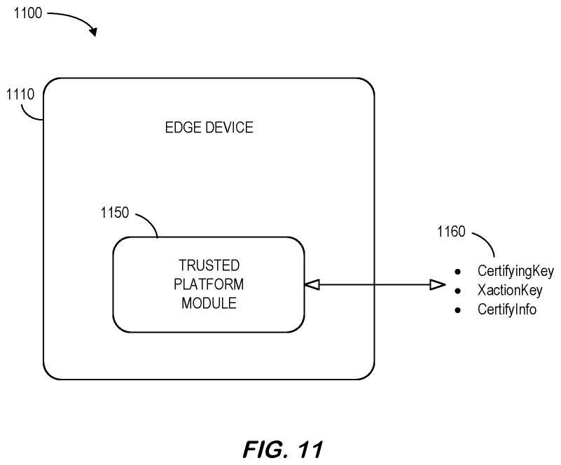

At S210, an edge device computer processor may receive, from a secure, distributed transaction ledger, information about a “task contract” published by a publisher device (that is, a device that wants a task performed but is unable to do so itself). As used, herein, the phrase “task contract” might refer to, for example, a compute transaction task, such as a series of algorithms associated with artificial intelligence, image recognition, etc. As another example, a task contract might be associated with a physical task to be performed by one or more automated devices (e.g., one robot might weigh an item to be moved, another robot might then move the item from a first location to a second location, etc.). According to some embodiments a single task contract might include both compute transactions and physical tasks. The received information may include, for example, an indication of a benefit (e.g., a payment to be made in exchange for performing the task) and encryption information. According to some embodiments, the received information may further include an indication of at least one resource requirement associated with a compute transaction task (e.g., an amount of memory, CPU speed, etc.). The edge device might be associated with, for example, a PC, a tablet computer, a smartphone, a robot, a vehicle, an autonomous vehicle, a set-top box, etc. According to some embodiments, the secure, distributed transaction ledger comprises blockchain technology that is controlled by a single, centralized entity or by multiple, distributed entities. The received information about the published task contract might further includes, for example, a high-level task description, a deadline, a processing speed requirement, a computer memory requirement, an acceptance payment requirement, etc. Note that the information about the published task contract might be received via a subscription model (that is, the edge device might subscribe to receive such posts from the transaction ledger). As described with respect to FIG. 11, the encryption information included in the published task contract might be associated with a public encryption key (e.g., a public Pretty-Good-Privacy (“PGP”) encryption key).

At S220, the received information may be evaluated in accordance with resources locally available at the edge device. For example, the edge device might determine if it capable of performing the task by the deadline, if the amount of payment is sufficient, etc. At S230, responsive to said evaluation, the edge device may transmit to the secure, distributed transaction ledger an indication of acceptance of the published task contract. According to some embodiments, the indication of acceptance transmitted to the secure, distributed transaction ledger includes a small payment (e.g., the payment may block other edge devices from agreeing to perform the same task). According to some embodiments, an edge device might simply ignore a task contract if it will not be accepted (that is, an explicit “decline” message from an edge device might not be required).

The edge device may then execute physical tasks and/or compute transactions associated with the published task contract. Upon completion of execution of the compute transactions, for example, the edge device may arrange to receive the benefit associated with the published task contract. Note that an edge device might receive information about a plurality of published task contracts and evaluation of one published task contract may be based, at least in part, on information about another published task contact. For example, the edge device might select a task contact associated with the highest payment for performing the task.

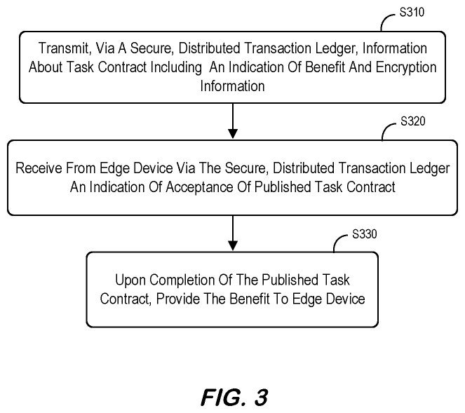

FIG. 3 is a publisher device method in accordance with some embodiments. At S310, the publisher device may transmit, via a secure, distributed transaction ledger, information about a task contract published including an indication of a benefit (e.g., a payment amount to be provide when the task is complete) and encryption information. When the task contract is associated with a compute transaction task, the information may further include an indication of at least one resource requirement associated with a compute transaction task (CPU speed, deadline, computer memory, etc.). At S320, the publisher device may receive, from an edge device via the secure, distributed transaction ledger, an indication of acceptance of the published task contract. Upon completion of the published task contract, the publisher device may arrange to provide the benefit to the edge device at S330 (e.g., vie a credit card payment, bitcoin account, etc.).

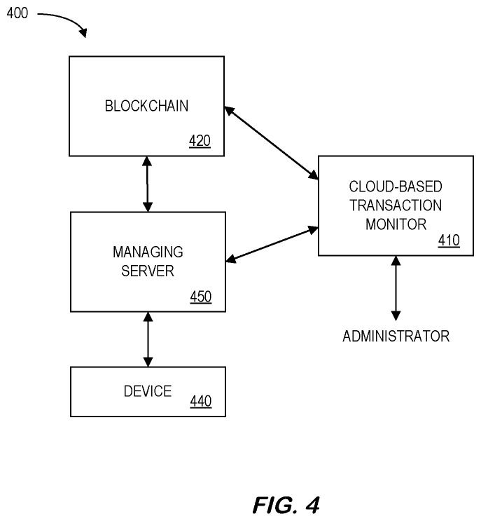

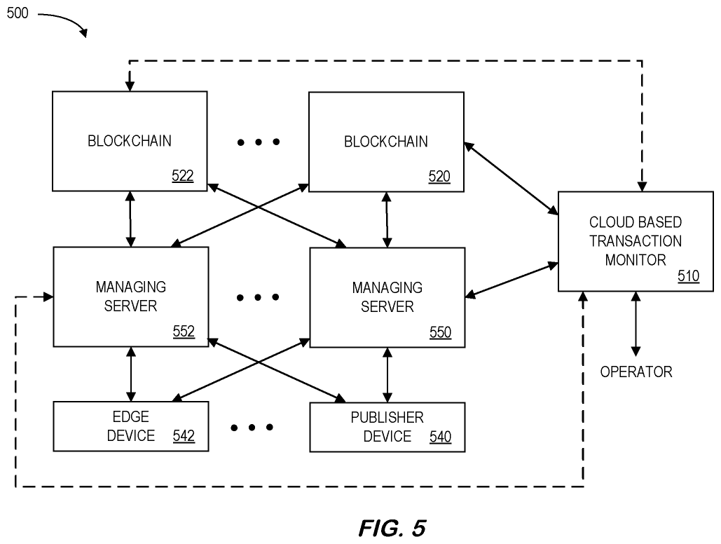

Thus, blockchain may be used to enable a secure brokering of distributed compute transactions. In this way, embodiments may allow for a formalized connection between devices that were not previously set up to talk to each other (that is, no formal network protocol was previously agreed upon by the edge and publisher devices). FIG. 4 is a system 400 implementing blockchain enabled compute transaction distribution with validation according to some embodiments. A cloud-based transaction monitor 410 may provide transaction integrity data via a web browser and exchange information with a blockchain 420 and a managing server 450 via Representational State Transfer (“REST”) web services. The REST web services may, for example, provide interoperability between computer systems on the Internet (e.g., by allowing requesting systems to access and manipulate textual representations of web resources using a uniform, predefined set of stateless operations). According to some embodiments, portions of the managing server 450 may be associated with a MySQL or Oracle® database. In this way, the managing server 450 and blockchain 420 can be used to provide transaction level verification for a device 440 (e.g., a publisher or edge device). Although FIG. 4 illustrates a system 400 with a single blockchain 420 and managing server 450, note that embodiments may employ other topologies. For example, FIG. 5 is a system 500 implementing blockchain enabled compute transaction distribution with multiple devices in accordance with some embodiments. In particular, an additional blockchain 522 and managing server 552 may provide protection for a publisher device 540 and edge device 542. As illustrated in FIG. 5, each managing server 550, 552 may be associated with multiple blockchains 520, 522 providing additional protection for the system 500 (e.g., by storing information at multiple, geographically disperse nodes making cyber-attacks impractical). That is, each verifier (e.g., managing service) may commit a brief summary to an independent data store and, once recorded, the information cannot be changed without detection to provide a tamper-proof System of Records (“SoR”).

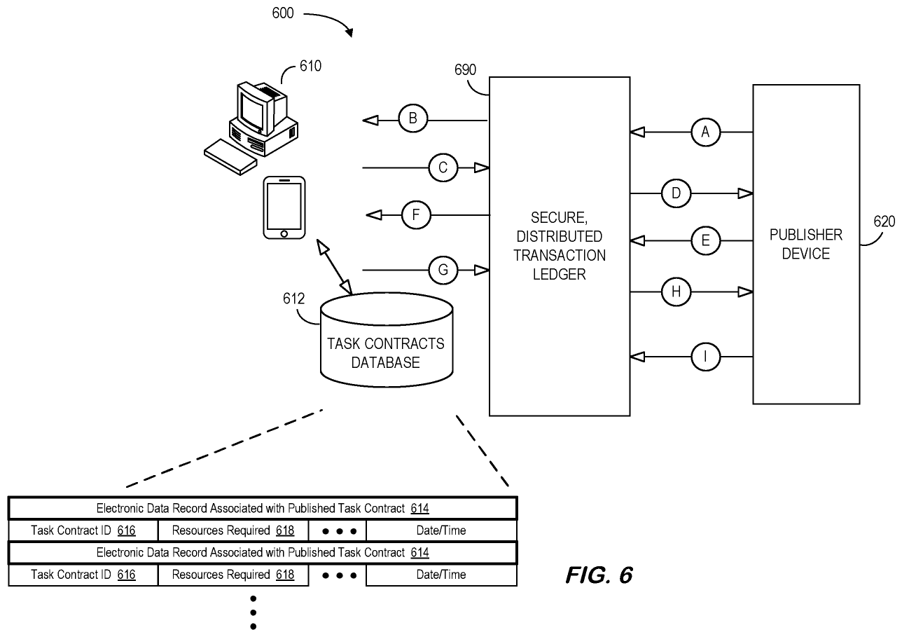

Thus, embodiments may provide secure blockchain enabled brokerage of distributed compute transactions. FIG. 6 is an information flow diagram 600 according to some embodiments. Initially, a publisher device 620 may record a task contract in a secure, distributed transaction ledger 690 at (A). An edge device 610 may receive information about the task contract at (B) (e.g., via a subscriber-publisher protocol). According to some embodiments, information about the task contact may be stored into and/or retrieved from a task contracts database 612 at the edge device (e.g., the task contracts database 612 might store electronic data records associated with published task contracts 614, including a task contract identifier 616, resources required 618, a deadline date and/or time, etc.). The edge device 610 may evaluate the task contract and, if appropriate, transmit an indication of acceptance to the transaction ledger 690 at (C). The publisher device 620 learns of the acceptance at (D) and provides additional information about the task that needs to be performed (e.g., specific compute transactions) to the edge device 610 at (E) and (F). When the task is complete, the publisher device 620 may be notified via the transaction ledger at (G) and (H). The publisher device 620 and/or transaction ledger 690 may then arrange to release the promised benefit (e.g., payment) to the edge device 610 at (I).

Thus, embodiments may let publisher and edge devices 620, 610 communicate the availability of tasks or resources in a trusted way without a central authority. Embodiments may use blockchain technology to develop a secure and trusted way for devices that have not previously communicated (i.e., “stranger” devices) to broker transactions (as described in connection with FIG. 11) and help enable communication over a public network in secure, peer-to-peer fashion.

Note that a blockchain contract may define a set of functions providing a “task-board” where a substantial number of edge devices can publish, subscribe, and purchase tasks. Digital currency may be provided as payment for the completion of a task. This money may be kept in “escrow” by the contract until the task is completed (or the task is canceled).

A device, as a publisher, may add a task with payment to the blockchain contract. This function may include a high-level task info, resources required, difficulty, and a public key for the device. When the task is purchased, the publisher device 620 may receive a public key of the edge device 610 purchaser from the blockchain contract. An edge device 610, as a subscriber, can subscribe to the task-board and see any tasks that have been posted. To buy a task and lock it out in the contract (so no one other devices can work on it), the edge device 610 might pay a small purchase fee. The purchaser edge device 610 may provide a public key to the contract along with the payment for a task. In return, the edge device 610 may receive the public key and IP address of the publisher device 620. This key can be used, according to some embodiments, to encrypt data exchanged between the publisher device 620 and the edge device 610 to start the task. Using the exchanged public keys though the blockchain contract, the two devices 610, 620 (who previously did not know each other) are now able to trust each other and communicate securely. After the task has been performed (and the result provided), both devices 610, 620 may acknowledge via the blockchain contact that the task is complete. The contract may then release the funds and pay the purchaser edge device 610.

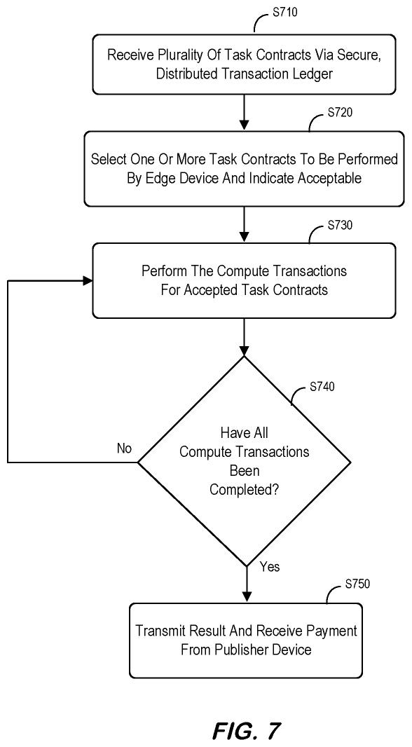

FIG. 7 is a more detailed edge device method in accordance with some embodiments. At S710, the edge device may receive a plurality of task contracts via a secure, distributed ledger. Note that different task contracts might be associated with multiple publisher devices or a single publisher device. At S720, the edge device selects one or more task contracts that it will perform (e.g., based on available compute resources and payment amounts associated with the tasks). After transmitting an indication of acceptance, the edge device may begin performing the compute transactions associated with the task contract at S730. If all transactions associated with the task contract are not yet complete at S740, the process simply continues performing transactions at S730. When all transactions associated with the task contract are finally complete at S740, the edge device transmits the result (e.g., to be received by the publisher device associated with the task contract) and receives payment at S750.

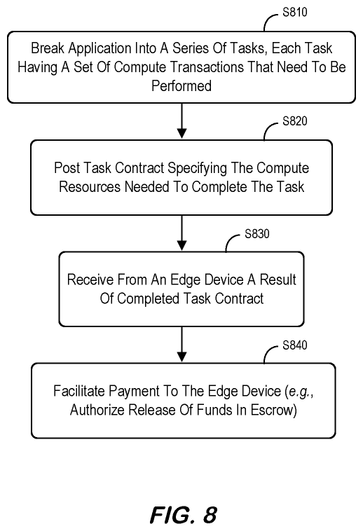

FIG. 8 is a more detailed publisher device method in accordance with some embodiments. At S810, a publisher device may break an application into a series of tasks, with each task having a set of compute transactions that need to be performed. The combined works of the tasks might be associated with, for example, an image recognition process or a machine learning algorithm. The publisher device may post (via a secure, distributed transaction ledger) a task contract specifying the compute resources needed to complete the task (e.g., CPU speed, latency, etc.) at S820. At S830, the publisher device receives, from an edge device, a result of a completed task contract. The publisher device may then facilitate payment to the edge device at S840 (e.g., by authorizing funds to be released from escrow via the secure, distributed transaction ledge).

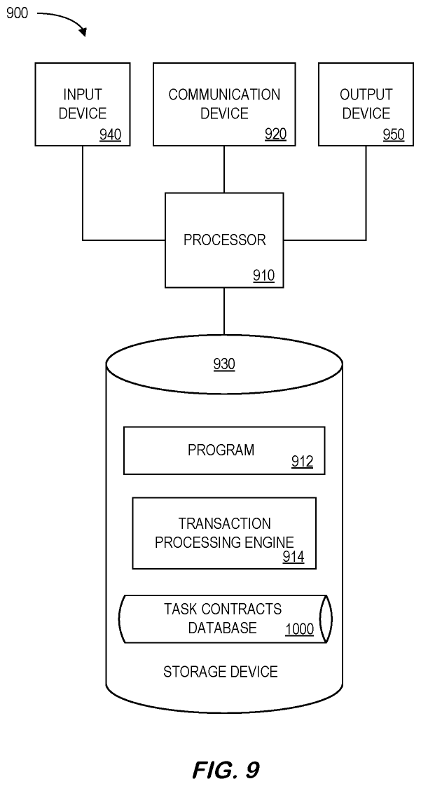

Embodiments described herein may comprise a tool to help broker secure, distributed compute transactions and may be implemented using any number of different hardware configurations. For example, FIG. 9 illustrates a platform 900 that may be, for example, associated with the devices 110, 120 of FIG. 1 (as well as other systems described herein). The platform 900 comprises a processor 910, such as one or more commercially available Central Processing Units (“CPUs”) in the form of one-chip microprocessors, coupled to a communication device 920 configured to communicate via a communication network (not shown in FIG. 9). The communication device 920 may be used to communicate, for example, with one or more remote devices, servers, and/or a ledger. Note that communications exchanged via the communication device 920 may utilize security features, such as those between a public internet user and an internal network of an insurance enterprise. The security features might be associated with, for example, web servers, firewalls, and/or Public Key Infrastructure (“PKI”) devices. The platform 900 further includes an input device 940 (e.g., a mouse and/or keyboard to enter information about a distributed transaction ledger, a task contract, edge device compute resources, etc.) and an output device 950 (e.g., to output usage reports, arrange for a transfer of funds, etc.).

The processor 910 also communicates with a storage device 930. The storage device 930 may comprise any appropriate information storage device, including combinations of magnetic storage devices (e.g., a hard disk drive), optical storage devices, mobile telephones, and/or semiconductor memory devices. The storage device 930 stores a program 912 and a transaction processing engine for controlling the processor 910. The processor 910 performs instructions of the programs 912, 914, and thereby operates in accordance with any of the embodiments described herein. When the processor 910 is associated with an edge device, for example, it may receive, via a secure, distributed transaction ledger (e.g., associated with blockchain technology), information about a task contract published by a publisher device including an indication of a benefit and encryption information. The processor 910 may evaluate the received information in accordance with resources locally available at the edge device, and, responsive to said evaluation, transmit to the secure, distributed transaction ledger an indication of acceptance of the published task contract. According to some embodiments, the processor 910 may execute the published task contract, and, upon completion, arrange to receive the benefit associated with the published task contract. Similarly, when the processor 910 is associated with a publisher device (instead of an edge device), it may publish task contracts, receive task results, facilitate payments, etc.

The program 912 may be stored in a compressed, compiled, uncompiled and/or encrypted format. The program 912 may furthermore include other program elements, such as an operating system, a database management system, and/or device drivers used by the processor 910 to interface with peripheral devices.

As used herein, information may be “received” by or “transmitted” to, for example: (i) the platform 900 from another device; or (ii) a software application or module within the platform 900 from another software application, module, or any other source.

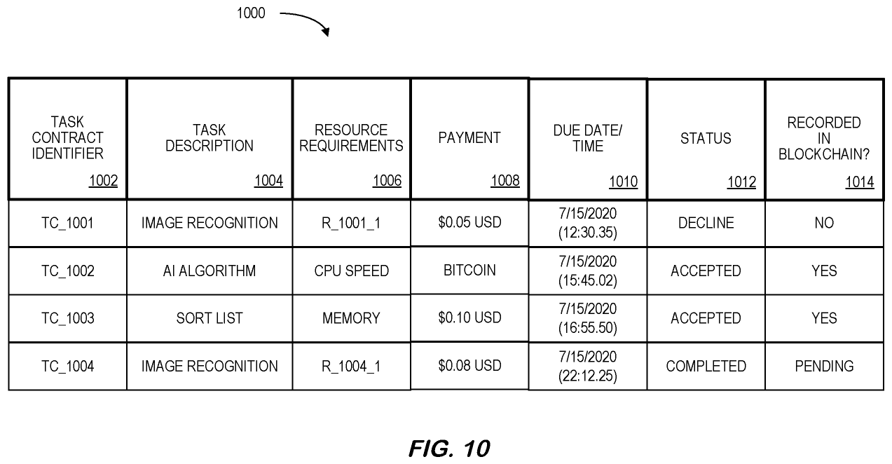

In some embodiments (such as shown in FIG. 9), the storage device 930 further stores task contracts database 1000. An example of a database that might be used in connection with the platform 900 will now be described in detail with respect to FIG. 10. Note that the database described herein is only an example, and additional and/or different information may be stored therein. Moreover, various databases might be split or combined in accordance with any of the embodiments described herein. For example, the task contracts database 1000 might be combined with and/or linked to the program 912.

Referring to FIG. 10, a table is shown that represents the industrial asset database 1000 that may be stored at the platform 900 in accordance with some embodiments. The table may include, for example, entries identifying task contracts distributed via a supply chain. The table may also define fields 1002, 1004, 1006, 1008, 1010, 1012, 1014 for each of the entries. The fields 1002, 1004, 1006, 1008, 1010, 1012, 1014 may, according to some embodiments, specify: a task contract identifier 1002, a task description 1004, resource requirements 1006, payment 1008, a due data and time 1010, a status 1012, and an indication 1014 of whether or not a task event was recorded via a blockchain transaction ledger. The task contracts database 1000 may be created and updated, for example, based on information electrically received from remote publisher devices, edge devices, and/or distributed transaction ledger devices.

The task contract identifier 1002 may be, for example, a unique alphanumeric code identifying a task that a publisher device wants to have executed. The task description 1004 may provide a high-level overview of the task and the resource requirements 1006 might specify the compute resources that are needed to perform compute transactions of the task (e.g., CPU speed, bandwidth, memory usage, etc.). The payment 1008 might indicate a benefit that an edge device will receive when the task is complement. The due date and time 1010 may comprise a deadline by when the task must be complete, a turn-around requirement, etc. The status 1012 might indicate fi the task was accepted, declined, completed, canceled, etc. The indication 1014 might specify whether or not a task event was recorded via a blockchain transaction ledger.

FIG. 11 illustrates an encryption technique 1100 according to some embodiments. In particular, an edge device 1110 might include a Trusted Platform Module (“TPM”) 1150. As used herein, the phrase TPM might refer to, for example, a secure crypto-processor with a dedicated microcontroller designed to secure hardware through integrated cryptographic keys, such as one that conforms with International Organization for Standardization (“ISO”)/International Electrotechnical Commission (“IEC”) standard 11889. As will now be described the TPM 1150 may exchange information 1160 associated with a CertifyingKey, XactionKey, and CertifyInfo.

Note that keys must be trusted by each relying party to be of value (for example, a publisher must believe the subscriber's key is really associated with that subscriber and therefore the data signed by the subscriber's key). Normally, this is done by having a mutually trusted entity (called a “Certification Authority”) sign a certificate which states that the associated key is trusted. The owner of the key may then use the key to sign information and pass the information to a relying party along with key's signed certificate. The relying party may verify that the certificate is signed by the mutually trusted entity then verify the data. The signing party (e.g., the subscriber) would typically re-use the key again for a different transaction. This, however, might violate the anonymity principles associated with blockchain because someone observing the traffic could detect that two transactions were performed by the same entity.

To solve this, an entity (for example a subscriber) may create a key that is trusted (by having the certificate signed) by a commonly trusted entity (for example, a server managing contracts). That key is referred to herein as the “CertifyingKey.” When a transaction is agreed upon, the subscriber creates a new ephemeral key called the “XactionKey.” Using a device such as a TPM 1150 (or other hardware token), the subscriber uses the CertifyKey to sign the properties of the XactionKey creating “CertifyInfo.” This may be an internal operation and therefore trusted by the server managing the contracts. The public portion of the XactionKey may be sent along with the CertifyInfo to the server managing the contract. As the server trusts that the CertifyingKey will not produce CertifyInfo for a key which is not within the same device as the XactionKey, the server then signs a XactionKey certificate using its mutually trusted public key. Because the publisher trusts the mutually trusted public key, it can now trust that the XactionKey is bound to the subscriber.

During the above protocol, the binding of the negation steps with the XactionKey may be done by signing critical portions of the negotiation using the CertifyingKey (which is prior to its certification but once trust is established the binding can be proven). Other methods might include, for example, critical portions of the negotiations with the key generation process to the key's internal data which would be included in the CertifyInfo. Note that a new XactionKey and, therefore, new certification process, may be performed for each negation and transaction. That is, the XactionKey may be a “single use” or ephemeral key that will not let others determine task contracts that were performed by the same edge device. Thus, according to some embodiments, a publisher device public key may be associated with the publisher device and the publisher device public key, optionally along with information about the publisher device public key, may be signed by a certifying key trusted by the edge device. The publisher device public key may then be used to sign or encrypt transaction information (e.g., information about the task contract). Similarly, an edge device public key may be associated with the edge device and the edge device public key, optionally along with information about the edge device public key, may be signed by the certifying key trusted by the publisher device. The edge device public key may then be used to sign or encrypt transaction information (e.g., information about the task contract). Alternatively, key technologies such as Anonymous or Group signing keys can be used (in the TPM 1150 this is called Direct Anonymous Attestation (“DAA”)). In that case, a single group public key is bound to many private keys (e.g., over 50,000 private keys). Each signature is unique even when performed by the same key, and therefore traffic analysis will not be able to associate two transactions that came from the same subscriber. Here, the same XactionKey may be used (which can save the time needed to create a new XactionKey for each contract as in the other approach).

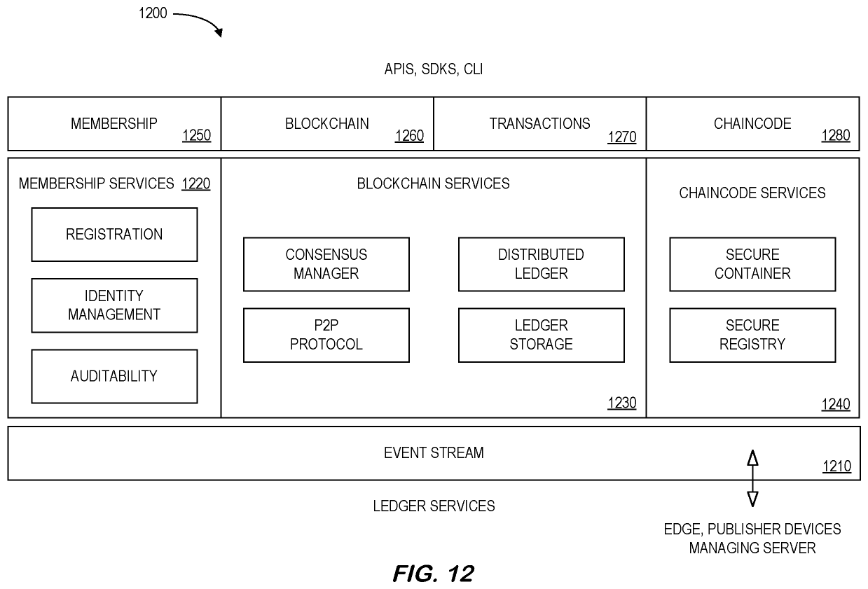

Embodiments may be associated with any type of distributed transaction ledger having a de-centralized consensus-based network that supports smart contracts, digital assets, record repositories, and/or cryptographic security. For example, FIG. 12 is a distributed transaction ledger reference architecture 1200 according to some embodiments. The architecture 1200 includes ledger services and an event stream 1210 that may contain network security service information (e.g., from a publisher device or edge device). Membership services 1220 (e.g., including registration, identity managements, and/or an auditability process) may manage identity, privacy, and confidentially for membership 1250 for the network security service. Blockchain services 1230 (e.g., including a consensus manager, Peer-to-Peer (“P2P”) protocol, a distributed transaction ledger, and/or ledger storage) may manage the distributed transaction ledger through a P2P protocol built on HTTP to maintain a single state that is replicated at many nodes to support blockchains 1260 and transactions 1270. Chaincode services 1240 (e.g., secure container and/or a secure registry associated with a smart contract) may help compartmentalize smart contract (or chaincode 1280) execution on validating nodes. Note that the environment may be a “locked down” and secured container with a set of signed base images that contain a secure OS and programming languages. Finally, APIs, Software Development Kits (“SDKs”), and/or a Command Line Interface (“CLI”) may be utilized to support a network security service via the reference architecture 1200.

Thus, embodiments may provide a way for devices to publish, subscribe, and/or purchase tasks without using a centralized authority. The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

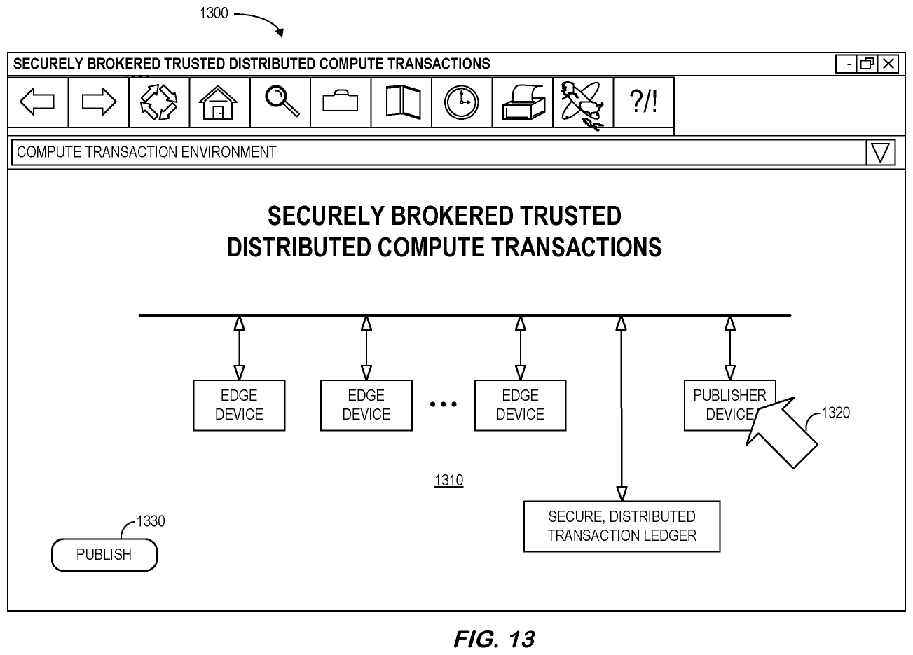

Although specific hardware and data configurations have been described herein, note that any number of other configurations may be provided in accordance with embodiments of the present invention (e.g., some of the information described herein may be combined or stored in external systems). Moreover, although embodiments have been described with respect to transaction information processing system, note that embodiments might be associated with other types of processing systems in general. Similarly, the configurations shown and described herein are provided only as examples, and other types of configurations, including display devices may support any of the embodiments. For example, FIG. 13 illustrates a computer display 1300 in accordance with some embodiments. The display 1300 includes a graphical representation 1310 of securely brokered trusted distributed compute transaction such that a user may select elements of the display (e.g., via a computer mouse pointer 1320 or touchscreen) to see further information and/or adjust details about that element (e.g., via a pop-up window). According to some embodiments, the display 1300 includes one or more selectable icons 1330 that can be used to publish a task contract, import data, save files, publish information, perform a blockchain validation, etc.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

1. A system to facilitate brokered distributed compute transactions, comprising:
an edge device communication port, associated with an edge device, to exchange information via a distributed communication network;
an edge device computer processor coupled to the edge device communication port and adapted to:
receive, via a secure, distributed transaction ledger, information about a task contract published by a publisher device including an indication of a benefit and encryption information,
evaluate the received information in accordance with resources locally available at the edge device, and
responsive to said evaluation, transmit to the secure, distributed transaction ledger an indication of acceptance of the published task contract.

2. The system of claim 1, wherein the task contract is associated with at least one of: (i) a compute transaction task, and (ii) a physical task to be performed by one or more automated devices.

3. The system of claim 1, wherein the secure, distributed transaction ledger comprises blockchain technology.

4. The system of claim 1, wherein the task contract is associated with a compute transaction task, and the published task contract further includes an indication of at least one resource requirement associated with the compute transaction task.

5. The system of claim 4, wherein the edge device computer processor is further adapted to:
execute compute transactions associated with the published task contract.

6. The system of claim 5, wherein the edge device computer processor is further adapted to:
upon completion of execution of the compute transactions, arrange to receive the benefit associated with the published task contract.

7. The system of claim 4, wherein the received information about the published task contract further includes at least one of: (i) a high-level task description, (ii) a deadline, (iii) a processing speed requirement, (iv) a computer memory requirement, and (v) an acceptance payment requirement.

8. The system of claim 4, wherein the information about the published task contract is received via a subscription.

9. The system of claim 4, wherein the indication of acceptance transmitted to the secure, distributed transaction ledger includes a payment.

10. The system of claim 4, wherein the edge device computer processor receives information about a plurality of published task contracts and evaluation of one published task contract is based at least in part on information about another published task contact.

11. The system of claim 4, wherein a publisher device public key is associated with the publisher device and the publisher device public key, optionally along with information about the publisher device public key, is signed by a certifying key trusted by the edge device.

12. The system of claim 11, wherein the publisher device public key is used to sign or encrypt transaction information.

13. The system of claim 12, wherein an edge device public key is associated with the edge device and the edge device public key, optionally along with information about the edge device public key, is signed by the certifying key trusted by the publisher device.

14. The system of claim 13, wherein the edge device public key is used to sign or encrypt transaction information.

15. The system of claim 14, wherein the public key for either the publisher or edge device comprises a direct anonymous attestation key.

16. The system of claim 4, wherein the edge device is associated with at least one of: (i) a personal computer, (ii) a tablet computer, (iii) a smartphone, (iv) a robot, (v) a vehicle, (vi) an autonomous vehicle, and (vii) a set-top box.

17. A system to facilitate brokered distributed compute transactions, comprising:
a publisher device communication port, associated with a publisher device, to exchange information via a distributed communication network;
a publisher device computer processor coupled to the publisher device communication port and adapted to:
transmit, via a secure, distributed transaction ledger, information about a task contract published by the publisher device including an indication of a benefit and encryption information,
receive from an edge device via the secure, distributed transaction ledger an indication of acceptance of the published task contract, and
upon completion of the published task contract, arrange to provide the benefit to the edge device.

18. The system of claim 17, wherein the secure, distributed transaction ledger comprises blockchain technology.

19. A computer-implemented method to facilitate brokered distributed compute transactions, comprising:
receiving, at an edge device computer processor from a secure, distributed transaction ledger, information about a task contract published by a publisher device including an indication of a benefit and encryption information;
evaluating the received information in accordance with resources locally available at the edge device; and
responsive to said evaluation, transmitting to the secure, distributed transaction ledger an indication of acceptance of the published task contract.

20. The method of claim 19, further comprising:
upon completion of the published task contract, arranging to receive the benefit associated with the published task contract.

21. A non-transitory, computer-readable medium storing instructions that, when executed by a computer processor, cause the computer processor to perform a method to facilitate brokered distributed compute transactions, the method comprising:
transmitting, via a secure, distributed transaction ledger, information about a task contract published by a publisher device including an indication of a benefit, and encryption information;
upon completion of the published task contract, arranging to provide the benefit to the edge device.

22. The medium of claim 21, wherein the secure, distributed transaction ledger comprises blockchain technology.
